(19) United States
(12) Patent Application Publication
(10) Pub. No.: US 2026/0129450 A1
(43) Pub. Date: May 7, 2026

(54) METHOD AND DEVICE FOR AUTHENTICATING A PRIMARY STATION

(71) Applicant: KONINKLIJKE PHILIPS N.V., EINDHOVEN (NL)

(72) Inventor: Oscar Garcia Morchon, Eindhoven (NL)

(21) Appl. No.: 19/117,982

(22) PCT Filed: Oct. 11, 2023
(86) PCT No.: PCT/EP2023/078118

§ 371 Date: Apr. 3, 2025

(30) Foreign Application Priority Data
Oct. 14, 2022 (EP) 22201543.0
Oct. 28, 2022 (EP) 22204451.3
Feb. 13, 2023 (EP) 23156343..8
Oct. 9, 2023 (EP) 23202325.9

(51) Int. Cl. H04W 12/08; H04W 12/106; H04W 74/0833

(52) U.S. Cl. CPC H04W 12/08; H04W 12/106; H04W 74/0833

(57) ABSTRACT

The present invention relates to a method, apparatus, and system for secure communication wherein an end device is adapted to: receive a first system information message from or through a first primary station, decode the first system information message and obtaining a “protection field”, use the “protection field” to determine the location of “security information”, and use “security information” to verify the received message and/or first primary station and/or send a subsequent secure message to the first primary station or a third primary station.

### FIELD OF THE INVENTION

The present invention relates to the field of wireless communications, and in particular to security aspects of the communication between a primary station, e.g. a base station, and a secondary station, e.g. a terminal or a mobile station forming a network. Other entities may be present in such a network, such a security entity.

### BACKGROUND OF THE INVENTION

In wireless networks, terminals connect to the network in order to exchange data. Security is crucial in particular for wireless devices where a physical interaction is not required to access the network. Wireless networks must thus implement some measures to be able to exclude devices that are not authorized in the network.

A conventional attack includes an attacker to impersonate an entity of the wireless network, and in particular the primary station, or base station. Thus, many countermeasures are aimed authenticating the identity of the various entities of the network.

In these telecommunication systems illustrated on FIG. 1, secondary stations 100 act as terminals or end devices (also referred to as User Equipment, UE, in 5G or End Device (ED) in this invention). The secondary station can access different types of services including voice and data services through primary stations 110 acting as base stations (also referred to as gNB in 5G) that are deployed in field. Each primary station 110 serves and communicates with the secondary stations 100 present in an area, also referred as a cell 111. The primary stations are connected to a core network (CN) 120—managed by a network operator—that controls the telecommunications systems and orchestrates the delivery of services.

As mentioned above, an attacker may impersonate network entities such as the primary station by using “False” base stations (FBS) to attack the secondary stations in many ways. A FBS behaves as a proper primary station managed by the network operator and aims at attracting UEs with different goals such as performing DoS attacks, obtaining private user data, performing Man in the Middle (MitM) attacks and subsequent attacks (e.g. aLTEr, imp4gt, network misconfiguration, . . . ), etc.

3GPP defines a system comprising a secondary station or end device ED (100) and a primary station or base station (110) as used in a wireless telecommunication system such as 2G or 3G or 4G or 5G. The ED connects to a core network through the primary device. The connection procedure between ED and primary station involves multiple steps:
The primary station broadcasting system information, in particular, MIB and SIB1;
The ED receiving system information of one or more primary stations;
The ED selecting a primary station based on a number of conditions such as signal strength, preferences, etc;
The ED obtaining random access parameters from the SIB1 of the selected primary station;
The ED sending a first random access message to the primary station;
The primary station replying with a second random access message to the ED.

The above procedure can be a 2 message RACH or a 4-message random access procedure. There is a need to secure the broadcast of system information, e.g., to ensure that EDs only join trusted primary stations or to ensure that an ED can verify broadcasted information by a primary station such as public warning messages or coverage information in Non-Terrestrial Networks. There is also the need to make sure that an ED does not join a FBS of an old generation when old generation base stations (e.g., 2G) have been already decommissioned.

An option is to attach some security information used to verify the integrity and freshness of the SIB in the SIBs themselves. However, SIBs are limited in size at the physical layer to around 3000 bits. Furthermore, SIBs already contain a considerable amount of data so that limited space is left for said security information. Typical size of the security information might range from 260 bits to a few thousands of bits, thus, in many cases, the security information does not fit in the same SIB that requires protection.

An option consists in broadcasting said security information in a SIB as well, e.g., a new SIB whose periodicity and timing is closely aligned with the periodicity and timing of existing system information, e.g., the same periodicity of MIB or SIB1 that are regularly broadcasted every 80 ms or 160 ms and that can be repeated multiple times in that period of time. A concrete option consists in broadcasting said security information with the same frequency and within the timeslot. However, this leads to a considerable usage of communication resources (spectrum usage) and energy.

Another problem refers to the fact that legacy primary devices, e.g., in 3G or 4G, might not support the broadcasting of system information. Thus, such systems relying on legacy technologies are still prone to attacks.

Another problem arises from the fact that low cost ambient IoT tags, small low power devices, may be requested to provide certain data, e.g., sensed data or identification data. However, they may only be willing to so for trusthworthy devices.

### SUMMARY OF THE INVENTION

One aim of the present invention is to alleviate the problems mentioned above.

Another aspect of the invention proposes that a primary device broadcasts the security information used to verify its system information on demand, i.e., based on a request from an ED.

Another aspect of the invention proposes that a second primary device broadcast the security information used to verify the system information broadcasted by a first legacy primary device on demand, i.e., based on a request from an ED.

The detailed embodiments illustrate further aspects of the invention where different embodiments can be combined with each other as appropriate.

Another aim of the present invention is to provide with a method which allows to increase the difficulty for attackers to access or impersonate an entity of the network.

Still another aim of the invention is a secondary station which is able to detect a false base station to ignore its messages.

Thus, in accordance with a first aspect of the invention, it is proposed an apparatus as claimed in claim 1. It is thus proposed an apparatus comprising:
a controller
a receiver and
a transmitter
wherein the receiver is adapted to receive a first system information message sent from or through a first primary station,
   wherein the controller is adapted to decode the first system information message and to obtain a protection field, the controller being adapted to use the protection field to determine a location of “security information”, and
   the controller being configured to use “security information” in order to verify the received message and/or the first primary station and/or
   to cause the transmitter to send a subsequent secure message to the first primary station or to a third primary station.

In a first variant of the first aspect of the invention, the apparatus is adapted to:
send a “security information request” to the first primary station or the third primary station, receive “security information” from the first primary station,
use the received “security information” to verify the previously received first system information message or a second system information message received from a second primary station.

Optionally, the apparatus may be adapted to send the security information request based on the determined location of security information.

Further the first variant, the apparatus may be adapted to send a “security information request” to a first primary station or a third primary station wherein the security information request requires security information for the verification of system information message and the request is sent if at least one of the following conditions are met:
the apparatus belongs to a given type
the system information message is transmitted by a primary station with a given identity,
the system information message is transmitted at a given time, or time frame,
the system information message is transmitted in a given area.

In a second variant of the first aspect, the “Security Information” of the first primary station is retrieved from a distributed ledger.

In another example of the above variants, the “security information request” may be sent in an initial PRACH message.

In a third variant of the first aspect which may be combined with the previous variants or options, a freshness of the first system information message is verified by comparing the local time of the apparatus with the signing time of the security information after correction with the timing advance indicated by the primary station whereby said timing advance is securely protected by means of the security information.

In a fourth variant of the first aspect which may be combined with the previous variants of options, the apparatus is capable of:
receiving a second system information message, and
verifying the second system information message based on the security information received to verify the first system information message.

Optionally, the apparatus uses a Merkle tree structure to verify the second system information message.

In a fifth variant of the first aspect which can be combined with any of the previous variants and options, the “protection field” in the first system information message includes a challenge that is used by the apparatus to verify the primary station by means of a first function P( ) and a secret internal state variable.

Optionally or alternatively, the “protection field” includes one or more identities used by the apparatus to determine whether the apparatus needs to further process the received first system information message.

Furthermore, the secret internal state variable may be updated based at least on the received challenge, the previous value of the secret internal state variable and a second function PP( ).

In a sixth variant which can be combined with the fifth variant or its options, the subsequent secure message includes data that is confidentiality protected based on the information in the “protection field”, the secret internal state information, and a third variable PPP( ).

In a seventh variant which can be combined with the fifth or sixth variants or their options, the subsequent secure message is integrity protected and/or a proof of the new secret internal state is obtained based on the information in the “protection field”, the secret internal state information, and a fourth function PPPP( ).

Further to the fifth to seventh variants, the first, second, third, and fourth functions may be one or more of:
a physical unclonable function,
a list of challenge-response values stored in memory,
a secret permutation,
a hash function such as ASCON-HASH,
an extendable output function such as ASCON-XOF,
an authenticated encryption algorithm such as ASCON-AE.

In accordance with a second aspect of the invention, it is proposed in claim 16 an apparatus comprising:
a controller,
a receiver and
a transmitter
   wherein the controller is adapted to cause the transmitter to broadcast a first system information message including a “protection field”,
and the receiver is adapted to receive a “security information request” and/or a secure message from an end device, ED.

In a first variant of the second aspect, the controller may be adapted to
securely process the secure message by extracting data included in the secure message based on the
information in the “protection field”, the secret internal state information of the ED, and/or
determine security information for the first system information message and transmit said security information.

Optionally, the receiver is adapted to receive a second secure message and securely process the second secure message.

Alternatively, the security information is included in a random-access response message.

In a second variant which can be combined with the first variant or its options, the “security information” integrity protects
fields in the random-access response message such as the timing advance and/or
properties of the security information request message such as the beam used to receive said message.

In accordance with a third aspect of the invention, it is proposed in claim 21 a method for secure communication with a primary station wherein the method comprises:
receiving a first system information message from or through a first primary station,
decoding the first system information message and obtaining a “protection field”,
using the “protection field” to determine a location of “security information”, and
   using “security information” to
      verify the received message and/or first primary station and/or
      send a subsequent secure message to the first primary station.

In accordance with a fourth aspect of the invention, it is proposed in claim 22 a method for secure communication with an end device wherein the method comprises:
broadcasting a first system information message including a “protection field”, receiving a “security information request” and/or a secure message from an end device.

In a fifth aspect of the invention, it is proposed a system comprising the apparatus of the first aspects or its variants and the apparatus of the second aspect or its variants.

In a sixth aspect of the invention, it is proposed a computer program for secure communication, wherein the program comprises instructions implementing the apparatus of first or second aspects.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

FIG. 1 already described, is a block diagram representing a cellular network in which the invention can be implemented;

FIG. 2 is a flowchart representing a method according to different aspects of the invention;

FIG. 3 is a flowchart representing a method according to different aspects of the invention focused on a security protocol for the communication with an end device;

FIG. 4 represents a centralized and distributed deployment scenarios of the invention;

FIG. 5 is a block diagram representing a secondary station in accordance with the first embodiment of the invention; and

FIG. 6 is a flowchart representing a method according to different aspects of the invention focused on the secure distribution of the contents in a SIB.

### DETAILED DESCRIPTION

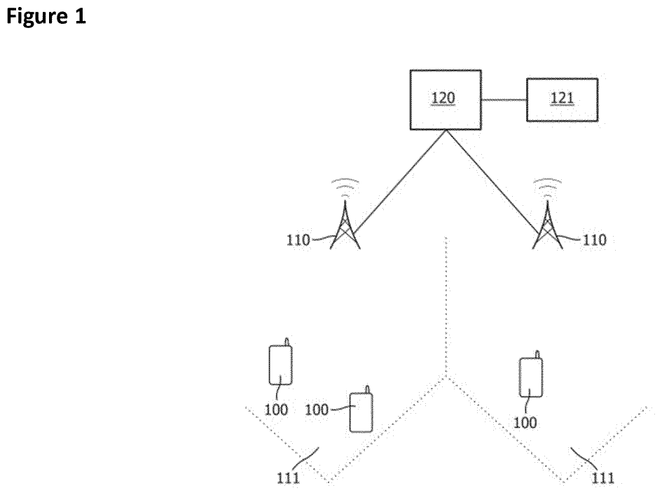

As seen above, the present invention can be implemented in a cellular network as for example a 5G network. As seen in relation with FIG. 1, such a cellular network comprises a plurality of terminals or secondary stations 100, being mobile devices (or UEs) that may travel from a network cell to another 111. Each cell 111 is served by a primary station 110 (or a gNodeB) which makes the interface between the secondary stations 100 and the Core Network 120.

Therefore, the secondary stations 100 communicate with the primary stations 110 on various radio channels, uplink (from the secondary stations to the primary station) and downlink (from the primary station to the secondary stations). Other radio channels exist, for example between secondary stations (for example Sidelink channels) and between primary stations (e.g. X2 interface), but are not represented for the sake of simplicity in FIG. 1. The embodiments of the invention could also be applied to these interfaces, however, the focus in the following parts of the description will be on the links between the secondary stations and the primary stations.

In order to allow secondary stations to connect to the network, the primary stations 110 may broadcast some configuration information over the cells 111. This configuration information includes Master Information Blocks (MIBs) and System Information Blocks. First, the MIB is a message broadcasted periodically (e.g. every 80 ms) and which includes all the required information to allow the decoding of the following SIBs.

```
MIB ::= SEQUENCE {
  systemFrameNumber BIT STRING (SIZE (6)),
  subCarrierSpacingCommon ENUMERATED {scs15or60, scs30or120},
  ssb-SubcarrierOffset INTEGER (0..15),
  dmrs-TypeA-Position ENUMERATED {pos2, pos3},
  pdcch-ConfigSIB1 INTEGER (0..255),
  cellBarred ENUMERATED {barred, notBarred},
  intraFreqReselection ENUMERATED {allowed, notAllowed},
  spare BIT STRING (SIZE (1))
}
```

Once the secondary station obtains the MIB, it can decode several System Information Blocks that can be transmitted periodically as well (e.g. every 80 ms, 160 ms) or on request from the secondary stations. These SIBs describe the operation and parameters of the network. In order to improve the security of the whole network, it is proposed to add digital signatures to these SIBs to prevent anyone from impersonating a primary station. A digital signature is a technique that binds an entity to the digital data. This binding can be independently verified by receiver as well as any third party. Thus, a digital signature is a cryptographic value that is calculated from the data and a secret key known only by the signer. The data corresponds in the present case to the payload carried in the SIBs themselves. The signature allows the secondary station to have assurance that the message belongs to the primary station.

In the example of 5G, one of the options available is that a Digital Signature Generator of the Core Network 120 generates and provides signatures to the primary stations 110 upon request from these primary stations for each message. Another option is that a Digital Signature Generator is included in each of the primary stations. This solution could be used for at least some of the messages, which would reduce the load on the Digital Signature Generators of the Core Network.

FIG. 5 is a block diagram representing a secondary station 500 in accordance with an embodiment of the invention. This secondary station comprises a communication unit 501 including a receiver 502 and a transmitter 503 adapted for communicating in a network, for example in a 5G cellular network.

The receiver 502 comprises at least one antenna or an antenna array with a plurality of antennas. This receiver may be adapted to receive messages sent from a plurality of primary stations. Such messages can be system information, SI, messages for configuration of the secondary station communication unit 501 in the communication network. These SI messages includes each a respective time reference information related to their respective primary station. The secondary station 500 also include a controller 504 to control the operation of the secondary station. This controller may be a Computer Programming Unit or other combination of hardware and software. The controller 504 is configured to check the validity of a received signature for each of the primary stations, and to check a cell identifier at least for each of the primary stations with a valid signature, Then, the controller 504 ignores time reference information from primary stations with a cell identifier being identical to another primary station and having an earlier value than the one from the other primary station. Eventually, the controller 504 deduces a local time reference from one or more of the time reference information originating from primary stations with a valid signature.

In a first overall embodiment addressing multiple problems, the connection procedure between ED and primary station involves the following steps:
1. The primary station broadcasting system information, in particular, MIB and SIB1, including a “protection field”;
2. The ED receiving system information of one or more primary stations using the “protection field” to determine the location of the “security information”;
3. The ED sending an “on demand indication” or “security information request” message;
4. The primary station computing/obtaining “security information” associated to the system information and sending it;
5. The ED receiving “security information” and
6. The ED verifying the “system information”.

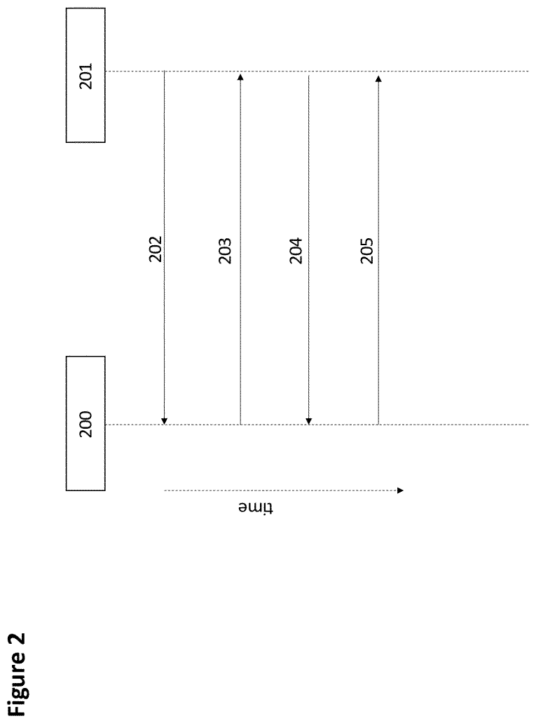

This is illustrated by means of FIG. 2 wherein 200 refers to an ED and 201 refers to a primary station. Messages are represented by means of arrows where the arrow direction represents to which entity the message is sent. Arrows/messages exchanged at the top are exchanged before arrows/messages exchanged further down. Message 202 represents a message including the “protected field”. Message 203 represents a message including the “on demand indication” or “security information request”. Message 204 represents the “security information”. Finally, message 205 indicates the final response of 200 after verification of the security information. An advantage of this construction is that an ED can receive system information such as MIB/SIB1 as usual without communication overhead, and if requested by the ED, the security information can be provided to the ED during, e.g., the random-access procedure.

In an aspect of the embodiment, Step 3 is performed when sending the PRACH message and Step 4 is performed before receiving the RAR message (message 2 of the random-access procedure). This allows for a simple integration in existing telecommunication systems.

In an aspect of the embodiment, the ED might cache in local storage, e.g., in the USIM the “security information” received in a previous message. This has the advantage of reducing the resource consumption since it removes the need for an ED to request again the “security information”.

In an aspect of the embodiment, the ED might have local access to the “security information” determined in the “protection field” so that the ED may not need to send an “on demand indication” message and may directly verify the “system information”. For instance, the ED may have been pre-configured with such information and retrieved/received it in a previous interaction.

In an embodiment, a primary station broadcasts system information including MIB and SIB1 with existing periodicities and SIB1 and/or MIB include a “protection field” indicating whether system information, e.g., the MIB and/or SIB1, are protected. If protected, the ED can take the decision to go on with the network access procedure with said primary station and retrieve the “security information” used to verify them.

In an embodiment, the “protection field” indicating whether system information blocks are protected is a flag, e.g., a single bit set to 1 or 0.

In an embodiment, the “protection field” indicating whether system information are protected is a structure containing one or multiple fields such as:
the protected system information, e.g., SIB1 and/or (MIB and SIB1) and/or (PCI and MIB and SIB1) and/or (PBCH fields and PCI and MIB and SIB1) and/or any other SIBs (e.g., SIB19 as used in non-terrestrial networks);
the system information that can be protected, e.g., PBCH fields and/or PCI and/or MIB and/or SIB1 and/or Time Value and/or other SIBs, etc
the cell physical identities, e.g., in the same area, for which security information can be requested on demand (e.g., a UE may wish to join a 4G cell without security information available, but a close-by 5G cell may broadcast the cell ID of the 4G cell, so that the UE may obtain the security information required to verify the 4G cell through/from the close-by 5G cell;
the structure/parts of the “security information”, e.g.,
   digital signature;
   certificate;
   current time value;
   past time value;
   signature algorithms.
the location of all or parts of security information, e.g., appended to the same SIB, transmitted in a different SIB;
the frequency band/timing resources used to transmit the security information, when transmitted in a different SIB;
the identities of the primary stations from which security information can be retrieved on-demand;
the algorithms used to protect the system information, e.g., ECDSA;
the security solutions or procedures that may be used to protect the system information, e.g., hash-based solution and/or signature/certificate based solution (as in embodiments below or as illustrated in TR 33.809);
an “on demand indication” for the whole, or parts, of the security information, e.g., digital signature is appended to the received system information and the certificate can be received on-demand;
a distributed ledger or the location in a distributed ledger storing the security information used to verify the system information of the cell.

In an aspect of the invention, the “protected field” may determine whether a digital signature is appended to the received SIB and if the certificate can be received on-demand.

In a further aspect of the invention, the “protected field” determines whether the signature and certificate can be received on-demand in a single SIB.

In a further aspect of the invention, the “protected field” determines whether the signature can be received in a different SIB transmitted periodically, and the certificate can be received on-demand in a different second SIB.

In a further aspect of the invention, the “security information” may be broadcasted in a first SIB to support the verification of system information distributed in another SIB.

In a further aspect of the invention, the “security information” includes a digital signature.

In a further aspect of the invention, the digital signature is based on one of ECDSA, RSA, or ECCSI.

In a further aspect of the invention, the digital signature refers to a message integrity code computed with a hash chain value not disclosed yet, as in TESLA.

In a further aspect of the invention, the “security information” includes a digital certificate, or a subset of a digital certificate, used to verify the public-key required to verify the digital signature.

In a further aspect of the invention, the “security information” includes a digital signature and/or a digital certificate.

In a further aspect of the invention, the ED is configured with trust anchors, e.g., public keys associated to private keys owned by, e.g., network operators. The private keys associated with trust anchors can be used to sign (create a certificate) the public key of public-key pair used by a primary device (primary station) to sign the system information broadcasted by the primary device.

In a further aspect of the invention, the public-key pair used by a primary device (primary station) to sign the system information refers to a hash-chain used in the TESLA scheme.

In a further aspect of the invention, the public-key pair used by a primary device (primary station) to sign the system information refers to a public-key pair AND a hash-chain used in the TESLA scheme.

In a further aspect of the invention, the “security information” includes an indication of which system information it protects when, e.g., SIB1 broadcasted from an initial time till an end time.

In a further aspect of the invention, the “security information” includes an indication of when the signature has been created, e.g., with reference to a global time such as the UTC time or a local time such as the SFN.

In a further aspect of the invention, the digital signature is computed over the system information, e.g., a SIB.

In a further aspect of the invention, the digital signature is computed over the MIB and/or SIB and/or fields in the PBCH channel where the MIB is broadcasted such as the PCI.

In a further aspect of the invention, the digital signature is computed over a time value, e.g., a UTC-based value, e.g., an UTC-based counter or the least significant bits of a UTC-based counter, or an SFN value.

In a further aspect of the invention, the digital signature that is distributed on demand covers/signs a timing advance value particular to the distance between ED and primary station. The reason for signing the TA value is that it is related to the propagation delay from primary station to ED. Assuming that the clocks of ED and primary station are perfectly synchronized, a MitM attacker might wish to manipulate the TA value (to a higher value) to be able to intercept, modify, inject messages because in this case, the ED thinks that the later reception of a message is not due to the presence of the MitM, but because of the propagation delay. In this context, if the ED receives the security information during the random-access procedure, e.g., together with Message B in a 2-message random access procedure, this same message also includes an estimation of the TA parameter as estimated by the primary station. Thus, this TA parameter may be signed to prevent an MitM from manipulating the communication.

In a further aspect of the invention, the digital signature that is distributed on demand covers/signs other communication parameters that specific to the communication link used by the ED, e.g., beam used to perform the random access procedure.

In a further aspect of the invention, the digital signature that is distributed on demand covers/signs/is computed using as input other parameters or fields included in the message used to distribute the digital signature, e.g., the fields of message B in a two-message random access procedure (RAR message) used to distribute the security information. In other words, the signature is computed taking as input the system information and at least a field in the message carrying the security information.

In a further aspect of the invention,
a) the primary station transmits (e.g., in Message B in a 2-message random access procedure) security information including signed information regarding, e.g., (1) the time Ts_sig of the primary station when sending the security information, (2) the timing advance TA observed/computed by the primary station, and/or (3) the time Ts_SI when the system information (e.g., SIB1, MIB) is sent; and/or
b) an end device, upon reception of the security information, determines whether the security information is fresh/recent by comparing

$$ABS ( ( ED\_time - TA ) - Ts\_sig )$$

With a T_w parameter, where ED_time is the local ED time and ABS(x) returns the absolute value of x; and/or
c) The end device, upon reception of the security information, verifies the system information is fresh by checking that system information is received at time Ts_SI where Ts_SI might be an absolute value or relative to the reception of the security information; and/or
d) The end device, upon reception of the security information, verifies the system information by using the information received in the security information.

In a further aspect of the invention, the primary station signs only static fields of the system information, i.e., leaving out variable fields such as SFN values, so that the security information can be used to verify multiple sets of system information, e.g., MIB or SIB1 transmitted at different time slots.

In a further aspect of the invention, the primary station signs both static and dynamic fields of the system information, i.e., including variable fields such as SFN values, so that the security information is specific for a given system information, e.g., MIB or SIB1 transmitted at a given time slots.

In a further aspect of the invention, the primary station indicates whether only static fields or also dynamic fields are signed. This can be indicated in the security information itself or indicated in the “protection field”.

In a further aspect of the invention, an ED requiring the verification of system information (e.g., MIB/SIB1) transmitted at timeslot k and receiving from the primary station security information capable to verify system information transmitted at timeslot k′, e.g., k′=k−1, may:
Not send a new request for new security information for timeslot k;
Verify the system information for timeslot k′ by replacing k with k′;
Check that the time difference between timeslots k and k′ is consistent with the signing time of primary station (related to k′) and the local time of the ED (related to the time linked to timeslot k when the system information was acquired).

In a further aspect of the invention, the ED verifies the system information by using the information received in the security information, e.g., a digital signature such as ECDSA or ECCSI or a Message Integrity Code used in a TESLA like scheme.

In a further aspect of the invention, an ED determines whether the security information is fresh/recent based on at least one of:
An absolute comparison, e.g., whether ABS((ED_time−TA)−Ts_sig)<T_w,
A relative comparison, e.g., ABS((ED_time−TA)−Ts_sig)/T_w,
A policy configured in the ED determining the T_w value,
A policy configured in the ED determining how much bigger ABS((ED_time−TA)−Ts_sig) can be compared with T_w,
A policy configured in the ED determining which absolute/relative comparison is acceptable in different contextual situations, e.g., normal access to a cell vs emergency situation. For instance, in normal access it may only be acceptable if ABS((ED_time−TA)−Ts_sig)/T_w<1, but in emergency access it may be acceptable if ABS((ED_time-TA)−Ts_sig)/T_w>1.

In a further aspect of the invention, an ED may have a configuration or policy so that the ED is not required to request/verify the security information of a cell even if the cell offers security information when the ED is accessing the cell/network in emergency mode.

In a further aspect of the invention, the primary station is configured by a network function in the core network, e.g., Digital Signature Network Function (DSnF), or by the OAM (Operations, Administration, and Maintenance entity) with at least one of:
keying materials such as signing keys,
digital certificates,
security policies,
schedule for the broadcast or on-demand delivery of security information.

In a further aspect of the invention, the primary station configures itself its own security information, e.g., keying materials such as signing keys, digital certificates, security policies, schedule for the broadcast or on-demand delivery of security information and uploads said public information (e.g., public key) to a distributed ledger (e.g., a block chain) so that this information is publicly available and retriable by other UEs.

In a further aspect of the invention, the primary station may be configured with a policy, e.g., by the OAM or a NF in the CN, determining which security procedures/countermeasure(s) (e.g., a hash-based solution (e.g., as described above or in Solution #14 or #19 in TR 33.809), signature/certificate-based (e.g., as described above or in Solution #20 or #27 in TR 33.809), none, etc) is/are:
allowed to use, enable, or disable and/or
under which conditions (e.g., time based, location based) and/or
By which devices.

This aspect of the invention and other aspects in this application (e.g., below) have the advantage of being able to support and/or negotiate and/or choose different types of solutions (hash-based, signature/certificate based . . . ) since different solutions may be (more or less) suitable depending on the use case, network or type of device.

In a further aspect of the invention, an ED is configured with a policy that may be hardcoded in a technical specification of a telecommunications standard according to which an ED/UE may not request security information if the ED is in certain situations, e.g., emergency access.

In a further aspect of the invention, the primary station may also include an indication (a security mechanism indication) of which security mechanism the primary station allows to use, has enabled, and/or disabled, in e.g., SIB1.

In a further aspect of the invention, the primary station includes said indication (security mechanism indication) in the “protection field” that determines how the system information is protected.

In a further aspect of the invention, the previous indication may be specific for an ED or a type of ED (e.g., an ED may be a standard UE, or an IoT UE, or a law enforcement UE, or an ambient IoT tag). For instance, the indication may indicate that
IoT UEs are required to use a signature/certificate-based solution (e.g., on demand) but shall not use a hash-based solution,
standard UEs may use either a signature/certificate-based solution (e.g., on demand) or a hash-based solution based on their local UE/ED policy,
ambient IoT tags may request security information for a given type.

In a further aspect of the invention, the security mechanism indication may be a bit flag specifying which countermeasures are enabled/disabled/supported.

In a further aspect of the invention, the primary station and/or the ED may support multiple countermeasures and negotiate which one is applied.

In a further aspect of the invention, if both ED and the primary station support multiple countermeasures, the choice of the security mechanism may be determined on-demand one of the parties (e.g., by ED).

In a further aspect of the invention, ED may request the use of “none” as a security countermeasure in certain cases, e.g., emergency situations. “none” may be expressed by simply not sending an “on demand indication”.

In a further aspect of the invention, the primary station may choose to accept/refuse the use of “none” as a security mechanism, depending on its security policy and/or the type of ED.

In a further aspect of the invention, an ED may be configured with a policy that determines which type of network the ED is allowed to join and/or the ED prefers to join, based on the security countermeasure(s) that the ED supports, and the ones offered/supported/used by the network. For instance, the ED may only be allowed to join a given type of network/cell, e.g., 3G cell/primary station, if it has (retrieved/received) security information allowing for the verification of said network/cell.

In a further aspect of the invention, an ED may comprise an apparatus and/or use a method to receive the indication (security mechanism indication) from a primary base station and determine the security mechanism to use for verification, e.g., system information verification, based on said indication and/or the supported security countermeasures by the ED and/or configured policy.

In a further aspect of the invention, the ED is configured with said policy by the network operator by means of standard signaling (e.g., with a NF in the CN) when communicating with the core network.

In a further aspect of the invention, the ED is configured with said policy before deployment.

In a further aspect of the invention, an ED is configured by a network function in the 5GS with above policy.

In a further aspect of the invention, an ED contains a USIM including above policy.

In a further aspect of the invention, the MIB or SIB1 includes an “on demand indication” related to the procedure required to retrieve security information required to verify the MIB and or SIB1.

In a further aspect of the invention, the ED requiring certain security information that is (maybe) broadcasted on-demand, firstly scans the time/frequency resources specified in the “protection field” and only if no SIB is detected, the ED sends a “security information request”. This is advantageous if, e.g., the distribution of the security information (message 204 in FIG. 2) has already been scheduled for a first ED (that has previously sent the security information request (message 203 in FIG. 2)), then the broadcast of such information may be signaled in messages 202 in FIG. 2 that may be broadcasted/distributed in a regular manner. Thus, when a second ED receives such a message 202 including the time/frequency resources where the security information is distributed, the second ED can directly access such security information.

In a further aspect of the invention, the primary station uses a combined approach between periodic broadcasting of security information and on demand delivery of security information. This allows ED to monitor the channel for regular updates, e.g., of certificates, without having to explicitly send a request; but it also allows retrieving the security information when needed. This primary station configuration is communicated by means of the “protection field”.

In a further aspect of the invention, the “protection field” specifies that the security information can be retrieved by sending an initial PRACH message.

In a further aspect of the invention, the “protection field” relates to a specific frequency/time domain where the ED has to send a “on demand indication” or “security information request” to trigger the distribution of security information.

In a further aspect of the invention, the “security information request” is transmitted by the ED by means of a unicast or multicast message.

In a further aspect of the invention, the “security information request” sent by the ED to the primary station might be a message including one or more of the following:
An anonymous signal common to all EDs indicating the “security information request”;
The system information that requires verification (e.g., SIB1, MIB, . . . );
Time when the system information has been read, is read, or will be read;
The required security information, e.g., a digital signature and/or certificate and/or.
The PCI of the cell for which the security information is required,
etc

In a further aspect of the invention, above fields might be explicit or implicit to the “on demand indication”/“security information request” message, e.g., the reception of an “on demand indication” at a given frequency band indicates that the UE requires a signature for some security information, e.g., SIB1, for the current SFN or for the current SFN AND MASK where MASK might be, e.g., 0x3F0 so that SFN AND MASK returns the 6 most significant bits of the SFN.

In a further aspect of the invention, the “protection field” may include a first NONCE (random number) and the “on demand protection”/“security information request” may include a second NONCE, and the “security information” is computed taking as input the first NONCE and/or the second NONCE. This allows the ED to verify the freshness of the security information. For instance, if the ED sends a second NONCE and a digital signature in the “security information” is computed using the second NONCE, the ED can verify the freshness of the message.

In a further aspect of the invention, upon reception of a “security information request” from an ED at the primary station, the primary station computes and/or gathers the required security information and sends the security information to the ED.

In a further aspect of the invention, the primary station computes the security information by signing the system information together with a current time value, e.g., the current UTC time or the current SFN value. This can allow the UE to verify the freshness of the security information if the UE is time synchronized, or this can allow the UE to learn the current time of the primary station if the security information also includes a signed second NONCE and the UE trusts the primary station as in above embodiment.

In a further aspect of the invention, the primary station computes the security information by signing the system information together with a past time value, e.g., the past UTC time and/or the part SFN value, when requested by the ED or when the system information was received by the ED.

In a further aspect of the invention, the primary station may compute the security information by signing the system information together with past and current time values.

In a further aspect of the invention, the primary station may compute the security information by including a used time value or a part of it (least significant bits (LSBs)). In particular, if the message including the “protection field” (message 202 in FIG. 2) includes a time value such as a UTC-based counter or SFN, the security information may only include part of the current time value (e.g., the least significant bits) so that the ED/UE can reconstruct the time value when the security information was computed. This is feasible because the ED/UE knows the time value included/received TO in the message including the “protection field”, knows the time elapsed DeltaT between the reception of the message including the “protection field” (message 202 in FIG. 2) and the message including the “security information” (message 204 in FIG. 2), and message 204 includes the LSBs of the time when computing the security information. The number of required LSBs equals log 2(DeltaT/Time_Accuracy_Of_A_Bit) rounded upwards times the time accuracy of a bit. For instance, DeltaT=9 ms, and Time_Accuracy_Of_A_Bit equals 1 ms, then log 2(DeltaT/Time_Accuracy_Of_A_Bit)>3 but it is less than 4. And thus, the number of required LSBs is 4.

In a related aspect of the invention, the primary station may compute the security information (signature) by including a time value or time difference that depends on the beam (SSB) used by the ED to connect to the primary station. This is required since, e.g., the same SIB1 is broadcasted multiple times over different beams with a given time delay as described in above embodiments.

In a related aspect of the invention, the ED takes into account that the security information (signature) is computed including a time value or time difference that depends on the beam (SSB) used by the ED to connect to the primary station. The ED takes this into account by knowing the specific timing of the SIB broadcasted in a given SSB when verifying the freshness of the message.

In a related aspect of the invention,
the CN or an AF sends a message that requires verification (such a message maybe, e.g., a public warning message, or other SIB) to one or more primary devices so that the primary devices broadcast said message on demand.
The CN or AF might optionally send a signature signing the message using a trust anchor linked to the CN or AF.
The primary device broadcasts the message in a SIB, e.g., SIB5, enhanced with a “protection field”.
The primary device optionally computes a signature over the SIB, if the signature has not been provided by CN or AF.
The primary device broadcasts the “security information” as determined in the “protection field”.

In a related aspect of the invention, the primary station sends the “security information” to the ED through a broadcast channel in a SIB.

In a related aspect of the invention, the security information may be distributed over the DL-SCH by means of:
unicast
unicast on-demand
periodic broadcast
broadcast on-demand

In a related aspect of the invention, the primary station may compute and distribute security information that includes a Merkle tree whose root is computed from the hash of the SIBs, e.g., SIB1, SIB2, . . . (as in Clause 7.3.1 in TS 38.300) and the signature is computed over the root of the Merkle tree. This has the advantage that the signing party, e.g., primary station only needs to compute a signature. This has the advantage that the receiving party, e.g., ED, only needs to verify a signature. This embodiment is of particular interest when an ED may request multiple SIBs, and those different SIBs may need to be verified independently.

In a related aspect of the invention, at least one of the Merkle tree leaves is the hash of a time value or a time value difference, e.g.:
the time of sending a given SIB, e.g. SIB1
the time difference between the sending of a given SIB and the time of sending the security information.
etc.

This allows verifying the freshness of the information a single time independently of the SIB verification.

In a related aspect of the invention, the sending of the security information may be done in a random access message such as message 2 of the random access procedure.

In a related aspect of the invention, the primary station delivering the security information is a UE-to-Network relay, that has received said security information from an access device such as a base station. It is to be noted that the UE-to-Network relay may play the role of ED when receiving the security information from the base station, and it may play the role of primary station when forwarding the security information to a remote UE.

In a related aspect of the invention, the primary station signing the security information may be a UE-to-Network relay.

In a related aspect of the invention, the ED receiving the “security information” from the primary station uses the signaled algorithm, e.g., digital signature algorithm, to verify the security information, e.g., the received digital signature.

In a related aspect of the invention, the signing algorithm is signaled in either the “protection field” in the received system information or in the received “security information”.

In a related aspect of the invention, the default signing algorithm, e.g., ECDSA, is not signaled; and only non-default signing algorithms, e.g., RSA, are indicated.

In a related aspect of the invention, the ED receives the MIB and observes certain fields that might give an indication that, e.g., the cell is barred, the ED might still proceed to retrieve SIB1, retrieve the security information (e.g., from the network or local storage), and verify whether the MIB/SIB1 is correct or not. This prevents an attacker from performing a DoS attack by giving a UE/ED the capability/configuration to do the verification of the received information.

In a related aspect of the invention, the ED receives the MIB and observes certain fields that might give an indication that, e.g., the cell is barred, the ED might use security information locally stored to verify it. The security information might have been received from a different primary device as described in other embodiments.

In a related aspect of the invention, the ED may verify the freshness of the messages, e.g., SIB with the “system information” including the “protecting field” or a subsequent SIB, by checking that the received time value in the “security information” is within a time window of the local time of the ED, e.g., that the received time value of the security information and the local time value are not further away than a time window.

In a related aspect of the invention, the ED may verify the freshness of the “system information” by checking that the time different between the current (e.g., when the primary station signed and sent the security information) and past time values (e.g., when the primary station sent the system information) in the received “security information” equals the time difference between the reception of the “system information” and “security information” up to a time window at the ED.

In a related aspect of the invention, the ED receiving the “security information” verifies the public key included in the digital certificate included in the “security information” by means of a trust anchor (e.g., public key of the operator) pre-installed in the ED or USIM or distributed by means of another “security information” message.

In a related aspect of the invention, the ED receiving the “security information” verifies the hash chain anchor (TESLA anchor) included in a digital certificate by means of a trust anchor (e.g., public key of the operator) pre-installed in the ED or USIM or distributed by means of another “security information” message.

In a related aspect of the invention, a first legacy primary device, e.g., a 4G eNB, does not support the distribution of “security information”. However, “security information” of the legacy primary device is made available on demand by a second primary device, e.g., a 5G primary station, located, e.g., in close vicinity or within communication range.

In a related aspect of the invention, a second primary device can receive from the core network or from a first primary device (e.g., over a wireless/wired Uu interface or Xn interface) link the system information (including timing) broadcasted by the first (legacy) primary device, and the second primary device will make available the corresponding “security information” associated to said system information on demand.

In a related aspect of the invention, an ED
receives system information from a first (legacy) primary station and a second primary station,
determines that the second primary device offers on-demand security information related to the first (legacy) primary station,
requests the second primary station security information of the first primary station,
receives the security information from first primary station,
uses the security information to verify the system information broadcasted by the first primary station.

For instance, the first primary station may be an NTN satellite or a base station, and the second primary station may be a terrestrial base station or another UE/ED, respectively. For instance, when the NTN satellite distributes a SIB, e.g., SIB19, a UE that is connected to a terrestrial base station may request/receive the security information for NTN satellite's SIB19 from the terrestrial base station. For instance, when a base station distributes a SIB, e.g., SIB1, a UE that needs to connect said base station may request/receive the security information for the base station from a UE it is connected to (over sidelink/PC5 interface).

In a related aspect of the invention, a first primary station requests a second primary station over the Xn interface at least one of (a) its system information (e.g., SIB1), (b) its security information (e.g., signature signing SIB1), (c) other parameters.

In a related aspect of the invention, a first primary station may request a second primary station over the Xn interface to deliver its security information (e.g., signature signing SIB1) for a given SIB, e.g., SIB1 broadcasted at a given time through a given SSB.

In a related aspect of the invention, a first primary station may request a second primary station over the Xn interface to deliver its security information (e.g., signature signing SIB1) upon reception of a security information request from an ED.

In a related aspect of the invention, the security information computed by a primary station signs the system information of multiple primary stations. This has the advantage that the ED has to retrieve a single security information, e.g., on demand.

In a related aspect of the invention, the security information computed by a primary station signs the system information of multiple primary stations, where the signature is computed over the root of a Merkle tree where the leaves correspond to system information (e.g., MIB/SIB1) of different primary stations.

In a related aspect of the invention, the ED sends a “security information request” to a first primary station requesting “security information” related to at least the first primary station and other primary stations. This has the advantage that the ED has to send less requests to retrieve the security information required to verify the system information of surrounding cells. The “security information request” may include the PCI of the cells for which the ED needs security information.

In a related aspect of the invention, the ED searches for primary stations looking for a primary station providing a good link quality, e.g., the primary stations transmitting synchronization signals with the strongest signals. The ED might then retrieve the SIB1 of one or more of those “selected” primary stations, and use the “protected field” to determine whether one of those primary stations offers the delivery of security information of one or more of the “selected” primary stations. The ED might then choose one of the primary stations and send a request the “chosen” primary station to receive not only the security information linked to its own system information, but security information linked to the system information of other primary stations. The delivery of the security information may happen over the “chosen” primary station or over all the “selected” primary stations. In this second case, the “chosen” primary station sends a request to distribute security information to the “selected” primary stations over the Xn interface.

In a related aspect of the invention, an ED may receive the security information from a primary station when the ED is connected to the primary station. This security information may be received on request from the ED (e.g., through an RRC message) or triggered by the primary station itself. This security information may then be used by the ED when performing a handover procedure whereby the ED needs to receive the synchronization signals of a new second primary station, determine the station identity (PCI), and may only perform the handover if the received security information allows for the successful verification and/or freshness verification of the system information received from the second primary station.

### Distributed Ledger

In a related aspect of the invention, the verification of a primary station's authenticity and legitimacy may be based on the records of a ledger, e.g., a distributed ledger such as a blockchain, that may be, e.g., owned, operated, and/or maintained by managing entities, e.g., 3GPP bodies, members, operators, NPN owner.

The ledger may include one or more of the following schemas:
Operator schema, which contains, e.g., id, licensing status, service type (e.g., terrestrial and/or non-terrestrial), territory, certificate(s), etc
Access device (e.g., base station, NCRs, smart repeaters, satellite, . . . ) schema, which contains, e.g., id, Operator_id, type, operational status, compliance status, certificate, movement trajectory (location over time), etc
Trusted Certificate authority schema, which contains, e.g., certification body name, root certificate, status, etc

In a related aspect of the invention, the ledger may be a blockchain, or a transparency tree as in RFC9162, or just a central trusted repository.

In a related aspect of the invention, the ledger may allow permissioned write access, such that only manufacturers and or operators that are authorized may write into it. As such, when an operator decides to deploy a base station, an entry including all or part of the information about the base station is entered/submitted into the ledger. When only part of the information about the base station is entered, it may only include a statement of e.g., the presence of a 4G base station in a given area. This may allow keeping private certain parameters network operators may not want to share.

In a related aspect of the invention, the base station may initially have an Operational status set to None, and is only updated to e.g., “Operational” once all checks and/or criteria defined by the managing entity(/ies) are met, e.g., the base station is tested and certified (e.g., compliance-certified), deployed, and is ready to operate. Other statuses e.g., “Under test” or “Down” may also be defined and assigned to the base station based on its state. This status may be included or updated in the ledger so that it is available to EDs/UEs for verification.

In a related aspect of the invention, the access device may initially have a compliance status set to None, and is only updated to e.g., “Compliant” or “non-Compliant” based on the reported results of conformance tests conducted by trusted, independent test labs and/or operational networks and or EDs/UEs. Future, continuous assessments/tests of the station's compliance, either by trusted test labs and/or the network, may result in a compliance status update (e.g., from “Compliant” to “non-Compliant”) of the access device. For public verification, a compliance status update may include the conditions under which the status was updated.

In a related aspect of the invention, UEs might report information about an access device to the ledger, e.g., the information may be, e.g., security information (e.g., a signature) distributed by an access device.

In a related aspect of the invention, a monitoring party may monitor for inconsistencies in the information stored in the ledger, e.g., if there are two entries that are inconsistent with each other indicating a potential attack, e.g., a FBS. This may be, e.g., two sets of security information that apparently are signed by the same access device at two (slightly) different locations. This may be, e.g., a set of security information signed by an access device (e.g., a mobile base station mounted on a vehicle) that deviates from the route of the vehicle (e.g., bus). This monitoring party may be an independent entity/device monitoring the correctness/compliancy of the data in the ledger.

In a related aspect of the invention, operators may be issued certificates by Trusted Certificate Authorities. Standardization bodies such as ETSI or 3GPP or GSMA may be/become Trusted Certificate Authorities. These certificates may be used to issue certificates for base stations. Base stations (in general, access devices) may use these certificates to derive security information. An ED may verify the certificate chain of trust, to establish the authenticity of the base station, before, while, or after connecting to the network, but preferably before. For instance, an ED may send an on-demand-indication (e.g., challenge, nonce), as part of, e.g., the random-access procedure's message 1. The base station may sign the nonce with its signing key, and include it, along with other required parameters e.g., access device id, Operator id, Certificate Authority id, signature, and/or signature digest in e.g., Random Access Response (i.e., random access procedure message 2).

In a related aspect of the invention, the randomly chosen preamble, or a part it, or the resources (time/frequency) used by the ED to send, e.g., the preamble, may play the role of the on-demand-indication (i.e., nonce/challenge) sent to the access device (e.g., gNB). In this case, no further data is added to the random-access procedure's, e.g., message 1.

In a related aspect of the invention, the on-demand indication may include additional parameters and/or conditions such as, a time-based counter and/or a time limit.

In a related aspect of the invention, EDs may store in e.g., local storage, records from the (public/private) ledger (e.g., base stations, operators, and/or trusted certificate authorities' schemas) which are used to verify stations' authenticity. Such records may be partly, or entirely, changed (e.g., deleted, updated) upon ED's connecting to the network and having access to the public ledger; they may be based on an on-demand request by ED or on a pull and push mechanism, considering ED's capabilities e.g., storage capabilities, roaming support, mobility status, etc.

In a related aspect of the invention, the ledger is public.

In a related aspect of the invention, the ledger is private, e.g., private to a non-public network or to the operator of a PLMN. Thus, an ED may only access the ledger if authenticated. For instance, authenticated during primary authentication as member of the PLMN or NPN. For instance, authenticated with the OAM. This aims at making sure that contents of the ledger remain private. Authentication may be based on pre-configured credentials in the ED/UE, e.g., a digital certificate or an authorization token or the ownership of a private key that can be used to prove the identity of the ED/UE by the ledger or the Identity and Access Management functionality around the ledger, and authorize a request to the information contained in the ledger.

In a related aspect of the invention, an ED may retrieve (or be configured) and store relevant information from the ledger, e.g., relevant information about public keys, access devices, etc for the area where the ED is currently located or may be located in the future. For instance, the ED may retrieve this information when it is in a given tracking area. For instance, this may be done based on a policy. For instance, a user may select the retrieval of information for a given location.

In a related aspect of the invention, depending on the ED's user consent settings, the network may process/analyze ED's data (e.g., location data, recurrent access devices used, etc) and curate the information from the ledger that is relevant to the ED. Based on the (continuous) analysis, the network may update (e.g., add, edit, delete) the records stored on the ED e.g., periodically, and/or based on policy, and/or based on an on-demand request by ED.

In a related aspect of the invention, an ED may use the stored relevant information to verify the security information received from an access device/primary station, e.g., after sending an on-demand indication or challenge. For instance, if a primary station returns security information (including a digital signature), then the ED can use a public key retrieved from the ledger to verify the digital signature.

In a related aspect of the invention, the ledger (i.e., all potential schemas for e.g., devices, access devices, trusted certificate authorities, etc) may be kept private and/or be privately owned by, e.g., Non-public Networks (NPN). The ledger, in terms of e.g., architecture and access rights, may be personalized based on the NPN's needs and requirements.

In a related aspect of the invention, EDs may temporarily store the information provided by the primary station/base station (e.g., id, Operator id, signature, signature fingerprint) and then transfer it for verification at the network (e.g., at AMF) as part of e.g., the registration request. The network can then use the information provided to, e.g., identify potential FBSs. In this case, the network may implement the monitoring entity mentioned in other embodiments.

In a related aspect of the invention, EDs may temporarily store the information provided by the primary station/base station (e.g., id, Operator id, signature) and then transfer it for verification to the home network (e.g., UDM) with, or as part of e.g., SUCI. In a related aspect of the invention, an ED may have a policy that allows/disallows to (temporarily) store the information provided by the primary station/base station (e.g., id, Operator id, signature) and then perform the necessary verifications (e.g., certificate chain of trust, operability, and compliancy checks) itself once ED has gained access to the network, including access to the ledger. The policy may also determine the conditions for allowing/disallowing the storage of the information. The policy may be configurable or hardcoded and always allow/disallow it.

In a related aspect of the invention, an ED may send a challenge/security information request that may include the Home Network Identifier (HNI) or Mobile Network Code (MNC) referencing ED's home network, wherein the primary station/base station is required to provide its signature, id, Operator id, and ED's nonce to be verified by ED's home network. Upon verification, ED's HN sends the verification result in a protected message, containing other parameters (e.g., home network public key identifier) to be delivered to ED. This allows EDs to access/verify primary stations even if they have not been configured with the trust anchors to verify them.

In a related aspect of the invention, the ED may send challenge/security information request that may include the Home Network Identifier (HNI) or Mobile Network Code (MNC) referencing ED's home network, this allows the primary station to determine whether the ED has been configured with a relevant trust anchor. This allows the primary station (e.g., gNB in a serving network) to request the home network (e.g., a NF in charge of signing) with the required security information by the ED. This may be, e.g., a digital signature so that the ED can verify that the home network allows the ED to use the primary station/gNB/access device.

In a related aspect of the invention, the signature and authenticity checks, performed on information provided by the primary station, may also include operational and compliance checks, i.e., checks verifying that the primary station is a trustworthy device to access and it performs well with the ED. In general, or in particular embodiments where it is mentioned, a certificate chain of trust verification and/or verification may refer to and/or include, but is not limited to, the process of verifying the validity period of an entity's (e.g., base station) certificate (e.g., Certificate_A), and the signature of the authority (e.g., Operator) that issued and signed Certificate_A, then repeat the process (i.e., verify the validity period of the authority's (e.g., Operator) certificate (e.g., Certificate_B), and the signature of the higher authority (e.g., Trusted certificate authority) that issued and signed Certificate_B) recursively until a Trusted certificate authority is reached, thus establishing the authenticity and trustworthiness of the entity.

In another aspect of the invention, verification may also refer to and/or include one or many of the following:
Operational check: whereby the operational status corresponding to the id of a device (e.g., PCI of the primary station/access device) is checked locally (e.g., a copy of the ledger records stored locally) or on the ledger's records.
Compliance check: whereby the compliance status corresponding to the id of a primary station/device (e.g., NCR) is checked locally (e.g., a copy of the ledger records stored locally) or on the ledger's records.

In another aspect of the invention, the PCI may be broadcasted in the PBCH as part of the synchronization signals of the primary station, next to the MIB. However, the PCI is a too short identifier to allow for unique identification of the primary station. Thus, the system information, e.g., SIB1 includes a unique primary station identifier that may be used by the ED to identify the primary station. Additional or alternatively, the unique primary station identifier may be constructed based on the location of the primary station and the PCI identifier making sure that a PCI is unique in a given area. The “protected information” and/or “security information” and/or SIBs may include such a unique primary station identifier.

In some situations, a network may comprise cells of multiple cellular generations, e.g., 2G, 3G, 4G, 5G. Over time, some of the cells of the oldest generations are decommissioned. However, an attacker may still place (fake) base stations of those older generations because the attack surface is bigger. An ED is not capable of determining whether a cell of one of those old cellular generations is properly operated by an operator, or a fake base station. In this context, in an aspect of this invention, the cellular system may be enhanced with a distributed ledger that is used by operators to include statements about base stations or base station types of cellular technologies (e.g., 2G, 3G) that are decommissioned or available in a certain area (e.g., in a tracking area). An ED/user equipment can look up such blockchain infrastructure to determine whether a base station is false or decommissioned, or not. An ED or user equipment can request/retrieve/download statements from a blockchain when the ED is connected or connecting to the network (e.g., send a “security information request”. The ED can perform local verification before connecting to a base station based on said locally stored statements. The ED may be able to retrieve, request, or receive statements for a given geographical area, e.g., the area where the UE is currently located or where the UE will be located. For instance, the ED/UE in a given tracking area may receive the statements related to that tracking area, by default or if subscribed to said statements. For instance, an ED in a given tracking area may send a request to the distributed ledger, or a network function interacting with it, to download statements for said tracking area. For instance, the primary station may receive a “security information request” and retrieve statements from the distributed leger. These requests may be for a specific PLMN or for a specific NPN or for multiple PLMNs. The network function may verify the location of the ED or authorization rights to access the data before authorizing the distribution of said statements. The ED going towards a given location/tracking area (e.g., an ED carried in a fly from Amsterdam to Boston) may request/retrieve the statements for the target area (Boston in this case), if a network function verifies that the ED is connected to a plane flying towards Boston.

In another aspect of the invention, primary stations/access devices (e.g., base stations) may broadcast (e.g., in SIBs) signed statements from the ledger, which confirm their status, such that EDs/UEs can verify whether primary cells/serving cells of the oldest generation are still commissioned to operate or not. Alternatively, or if an ED/UE fails to retrieve said statement, the ED/UE may request such statement from the primary station/access device e.g., when communicating PRACH, whereby the ED/UE establishes an RRC connection upon successful verification of the access device authenticity and/or commissioning status.

In another embodiment, where a UE goes into an RRC_INACTIVE state while served by a primary station/base station (e.g., source gNB), then later attempts to transition into RRC_CONNECTED under another primary station/base station (e.g., target gNB), upon retrieving the security context from the source primary station/gNB, this latter may verify (e.g., through the ledger) whether target primary station/gNB is legitimate and still commissioned, and only process (e.g., decrypt, integrity verify, and/or provide keys) the target primary station/gNB's request if the verification is successful. Additionally, source primary station/gNB may provide a signed statement to target primary station/gNB of the successful verification, which the target primary station/gNB may forward to the UE. Such a statement by the source primary station/gNB is equivalent to a ledger check, which the UE is spared. Upon verifying the statement from source primary station/gNB, and if successful, the UE may establish an RRC connection with target primary station/gNB and transition to RRC_CONNECTED.

In certain cases e.g., inter-gNB handover scenario, a UE can access a target primary station/cell without reading system information, as these are provided by the source primary station/cell (e.g., source gNB) along with at least a cell ID in the RRCReconfiguration message, which is received as part of the HANDOVER REQUEST ACKNOWLEDGE transmitted by target primary station/gNB to source primary station/gNB. In such cases, and in a further aspect of the invention, the target primary station/gNB may also include a signed statement from the ledger confirming status, which may be verified by either, or both, source primary station/gNB and the ED/UE. Alternatively, source primary station/gNB may check and verify a target primary station/cell's status before it initiates a handover procedure with said target cell; source primary station/gNB may then provide a statement to ED/UE for further verification as part of the RRCReconfiguration message.

In accordance with the above embodiments, it is proposed a method by which a primary station's legitimacy and authenticity is checked/verified against a ledger, wherein, the method may be implemented on a verifier (e.g., an ED) and involve verifying the security information (e.g., the signature, certificate chain of trust, and other criteria (e.g., operational and compliance status)) of an access device based on a ledger's records, whereby the verification may rely on network assistance, or not, e.g., done by the verifier itself, once the verifier has access to the network, or against a locally stored copy of the most-up-to-date records corresponding to said ledger.

This method may rely on different processes to obtain the security information, e.g., a process may be as in other embodiments:
an end device (e.g., UE) transmitting an on-demand indication (e.g., challenge) during the random-access procedure (e.g., random-access procedure message 1) to the primary station;
the primary station signing and computing a signature digest of the on-demand indication, adding parameters (e.g., primary station id, certificate authority id) required to perform checks/verifications to the response message (e.g., random-access response), and transmitting said response message to the verifier (e.g., end device).

### Application of the Invention to Non-Terrestrial Networks

An application of the invention may refer to non-terrestrial networks wherein non-terrestrial access devices such as satellites or unmanned aerial vehicles provide connectivity to ED/UEs. Important information that needs to be verified refers to data of the non-terrestrial devices such as ephemeris data. SIB19 was introduced by 3GPP in Release 17. This SIB provides NTN-specific parameters for the serving primary station and/or close primary station. In particular, SIB19 includes assistance information of the non-terrestrial access device, for example, Ephemeris data, common timing advance parameters, koffset, validity duration for UL synchronization epoch time, cell reference location, timing advance reporting during initial access, cell stop time as described in TS 38.331. If fake information is distributed or this information is modified, it can heavily affect the communications of the UEs/EDs because they will not be able to properly communicate. Thus, the content of SIB19 should be protected. To this end, this invention and the invention variants may be applicable. Examples of the application may include:

In an application, the contents of SIB19 may be stored in a distributed ledger that may be accessible by an ED or another primary station/NF on behalf of the ED so that the ED can verify the received parameters. When a new non-terrestrial primary station becomes available, e.g., when new satellites are put in orbit, the information of the non-terrestrial primary station is uploaded to the distributed ledger by the satellite operator. The information of the satellite may be retrieved by, e.g., the UE/ED when connected, or by a terrestrial primary station/NF on behalf of the UE/ED. The terrestrial primary station/NF may then distribute the security information to the UE/ED.

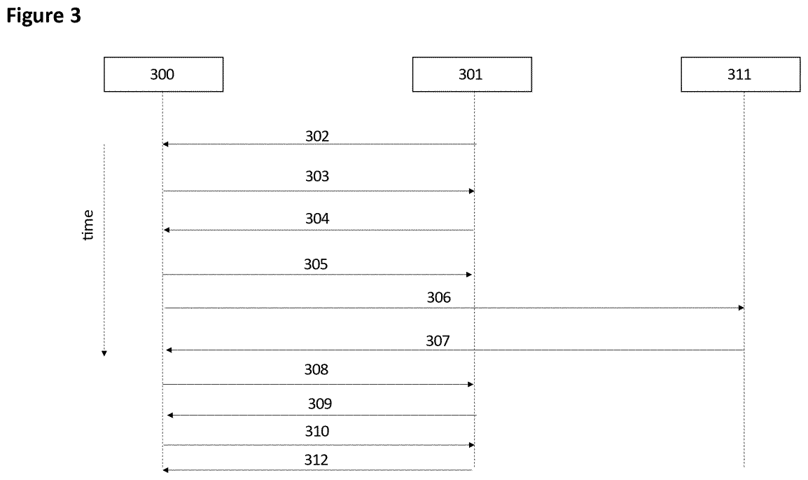

FIG. 3 illustrates how some of aspects described in this invention may be applied to the protection of SIB 19. Entities and messages 300-305 in FIG. 3 are equivalent to entities and messages 200-205 in FIG. 2. Additionally, entity 311 represents a second primary station (e.g., terrestrial primary station) or a NF or an AF. Message 306 represents a request from ED 300 to retrieve the security information for SIB 19 for a given non-terrestrial primary station. The request may also request the security information to verify the SIB 19 non-terrestrial primary stations available in a given area at a given time (e.g., for the current hour in the location where the ED is located). Entity 311 may return then one or more security information messages to entity 300. Entity 300 may then use the received security information to verify SIB19 (if already received). Additionally or alternatively, entity 300 may send a request to retrieve SIB19. This request may also include a security information request related to SIB19. Entity 301 then delivers SIB19 in message 309 and SIB19's security information in message 312. Additionally or alternatively, entity 300 may send a request to retrieve SIB19. This request may not include a security information request related to SIB19. Entity 301 then delivers SIB19 in message 309. The SIB, in this case SIB19, may include an indication of protection, so that Entity 300 may send a subsequent security information request in message 310. Entity 301 delivers SIB19's security information in message 312.

Additionally or alternatively, the managing entity of the non-terrestrial primary station may not want to make the information of SIB19 public and accessible to all EDs. Thus, the managing entity may select a key K for a given time period and use K to confidentiality protect the data in SIB19. An ED interested in the usage of the non-terrestrial primary station may send a request to the network (e.g., a NF) or an AF, e.g., representing the managing entity of the non-terrestrial primary station to get authorization to make use of said services. This request may be authenticated by means of AKMA (TS 33.535) or GBA. Upon authentication, the NF or AF may further check whether the ED is authorized, e.g., if the ED has subscribed to the services of the non-terrestrial access device. This may require sending a request to an authentication function such as AUSF or UDM where the ED profile may be located. Upon authentication, the AF/NF may securely deliver the key K to the ED.

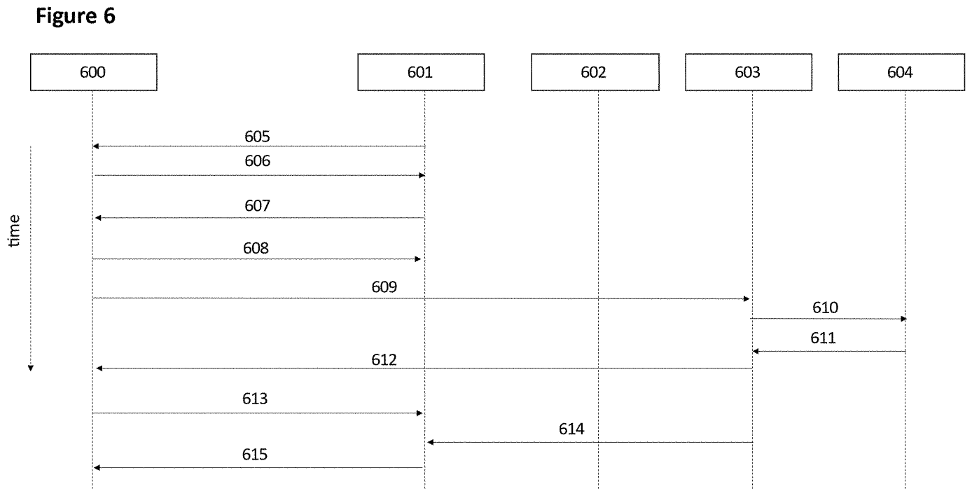

This overall approach is illustrated by means of FIG. 6 where entities 600, 601, 602, 603, and 604 represent an ED, a first primary station (e.g., a non-terrestrial primary station), a second primary station (e.g., a terrestrial primary station), a NF in the core network of the cellular system or an AF, and an authentication function, respectively. Message 605 represents the initial distribution of system information, e.g., MIB/SIB1. Messages 606/607 represent the initial process (random access procedure) to access the first primary station including a registration request. In this procedure, message 605 may indicate that certain SIBs are confidentiality protected, in this case, SIB19, and require authentication/authorization for accessing them. In this procedure, the security information request may be sent by the ED to the first primary station. The returned security information may indicate that certain SIBs are confidentiality protected, in this case, SIB19, and require authentication/authorization for accessing them. Message 609 represents a message or procedure towards the NF in the CN/AF in order to get authenticated/authorized to use the first primary station. This can be a network access message or part of the primary authentication. This request may be sent through a second primary station (e.g., if it refers to an AKMA procedure, or it may be sent through the first primary station where the first primary station may only allow such message/procedure, e.g., primary authentication. Once entity 603 has authenticated the ED, entity 604 may send a request to entity 604 (e.g., AUSF, UDM, or external data base) to verify that the ED has a valid subscription. The answer is provided in message 611. Based on it, entity 603 may provide entity 600, i.e., the ED, with key K used to protect SIB19. Additionally, or alternatively, the ED may receive the content of SIB19 in this message. In Step 613, ED may request further SIB19. In step 614, entity 603 may provide the first primary station with the SIB19 information, and/or the key K to protect the SIB19 information, and/or the protected data to be carried in the SIB19. Finally, in step 615, the protected information of the SIB19 is distributed by means of the SIB19. It is to be noted, that next to K, the ED receives other auxiliary data such as the protection algorithms used to protect the SIB information (e.g., NEA and or NIA algorithms). Protection may mean confidentiality and/or integrity protection.

### Application of the Invention to Ambient IoT

An aspect disclosed by this invention is how an ED/UE may receive security information on demand, e.g., during the random-access procedure. This invention therefore helps to protect the random-access procedure used by ED/UEs in cellular technologies such as 4G or 5G. Upcoming generations of cellular technologies will also deal with and give support to resource constraint IoT devices. These devices, also called ambient IoT tags, will be extremely simple. A reader, e.g., a base station/primary station, may be able to send a reading signal and the ambient IoT tag may just be able to send a reply, an answer, with, e.g., its identity, location, or sensed data. From this point of view, it makes sense if such a reading signal may be similar to the distribution of system information such as MIB or SIB1 so that the tag, when receiving/receive such signals can reply to them. Thus, it is meaningful to further align the procedure as in above invention variants with a security procedure to protect the communication with an ambient IoT device. Thus:

In an aspect of the invention, the first message 202 in FIG. 2 may refer to a message including system information and requesting an IoT device, e.g., an ambient IoT tag to provide a response with certain information the IoT device may have, e.g., its identity or sensor data; the second message 203 in FIG. 2 may refer to a potential response of the device that may include protected data for the primary station or another entity (e.g., NF or AF) behind the primary station; the third message 204 in FIG. 2 may refer to security information provided by the primary station to the ED so that the ED is capable of verifying the requesting entity. This data may be associated to the primary station or a requesting entity; the fourth message 205 in FIG. 2 may refer to a further potential response of the device that may include protected data for the primary station or another requesting entity (e.g., NF or AF) behind the primary station upon verification of the primary station or another requesting entity.

In such ambient IoT scenarios, ambient IoT tags may be very resource constraint and thus, they may not be capable of heavy computations. Thus, the following aspects of the invention may be applicable.

In an aspect of the invention, the primary station may send a challenge to an ED such as an ambient IoT device to retrieve certain data from the ED. The ED may have a policy only allowing the disclosure of data, even if encrypted, to trustworthy devices. Therefore, the received challenge may include a “protection field” providing system/identification information about the requesting primary station as well as indicating that security information is available. The ED may then reply with a message with the “on demand indication”/“security information request”. Upon reception, the requesting primary station sends the requested security information to the ED that verifies it, and if the verification is successful, sends the previously requested data. This requires two round trips to retrieve the data securely from the ED.

In a further aspect, the ED may include a function such as one-function, a physical unclonable function (PUF) or a HMAC that may take as input one or more parameters (challenge) in the “protection field” received in the first message 202 in FIG. 2 and generate a response. The function may be such that given the response it is difficult to compute the one or more input parameters (challenge). The function may be such that it is device specific, e.g., if it is based on a physical unclonable function or an HMAC taking as input a device specific key. For instance, a parameter in the “protection field” may be a first NONCE.

In a further aspect, the ED may reply in message 203 with a response that depends on the challenge in the “protection field”. The primary station (or a requesting entity behind the primary station) may use the response to identify the ED. For instance, the primary station (or a requesting entity behind the primary station) may have a mapping:
challenge, response_i, device_ID_i
   so that for a given response_i to a challenge can be used to identify the device_ID_i.

In a further aspect, the ED may have a function that generates a response R_j given the input challenge. The response R_j can be seen as the concatenation of two responses R_j1 and R_j2 such that R_j1 has length L1, and R_j2 has length L2. R_j1 may be sent in message 203 as in previous embodiment. While R_j2 may be used to encrypt the data to be transmitted by encrypting the data as the XOR with R_j2. This allows using R_j1 to identify the device and generated output, and once the device is identified, then the the primary station can use the (then known R_j2) to access the data.

In a further aspect of the invention, the ED/ambient IoT tag may be configured to determine whether it requires the verification of the primary station/requesting entity behind the primary station. This configuration may be based on a policy or a pre-configuration. If it requires the verification of the primary station, the ED/ambient IoT may send a “security information request” message 203 as per FIG. 2. This message may include a second NONCE. Additionally, or alternatively, the ED may use other embodiments as described below that directly aim at verifying the authenticity of the primary station given the initial message including the “protection field”.

In a further aspect of the invention, since generating random data in a resource constraint device may be difficult, the device may store random data in a read only memory, and use that random data as source of randomness.

In a further aspect of the invention, it may be wished that an IoT device 200 may only act on the received message 202 if this messaged is considered to be authorized. Thus, in an aspect of the invention, this message may be crafted to allow for its verification by the device 200. For instance, an approach may consist in including a nonce/counter and a MIC in message 202 where the MIC is computed with a key specific for device 200 and a nonce/counter where the device keeps track of the last used nonce/counter. If message 202 includes the counter and MIC, device 200 can recompute the MIC (e.g., assume that HMAC-SHA256 is used to compute the MIC, e.g., as the last 32 bits of the HMAC output), device 200 can verify whether the received MIC is correct and the counter included in message 202 is higher than the locally stored counter. This approach offers strong security, but it may be too demanding for a small IoT device. Another approach may consist in sending a challenge Ch in message 202 to device 200. Device 200 is configured with a secret/device specific function P( ) (e.g., a secret permutation) and a current internal state IS when Ch is applied to P( ) A requesting device (e.g., primary station 201) knowing the tag may select Ch such that P(Ch)=IS. The device may also be configured with a second secret device specific function PP( ) that is applied to a function G( ) of the received challenge Ch and the old IS, so that a new internal state IS' is computed as IS′=PP(G(Ch, IS)) and stored in the device if the check P(Ch)=IS succeeds. Furthermore, if the check P(Ch)=IS succeeds, then device 200 may send message 203 to the requesting device 201, e.g., a primary station. If this message 203 includes any private data D, such private data may be confidentiality protected by XORing it with a pseudo-random sequence derived by means of a third function PPP( ) that takes as inputs the received challenge Ch and the internal state IS. Message 203 may also include some bits related to the new internal state IS′ and/or transmitted data. For instance, if PP(Ch, IS)=TRUNC (PP′(G(Ch, IS))) and TRUNC (A) returns the b least significant bits of input A=PP′(G(Ch, IS)) that is k bit long, then Message 203 may return the k-b most significant bits of A. This is in general a fourth function PPPP( ) that takes as input the new internal state IS' and the transmitted data and whose output serves as a proof for the requesting device 201 that the new internal state IS' is correct and/or the received data is correct.

In an aspect of the invention, device 200 may include 4 functions P( ) PP( ) PPP( ) and PPPP( )
P( ) aims at verifying the request in message 202,
PP( ) aims at updating an internal state of the tag given the request in message 202 and/or the last internal state,
PPP( ) aims at generating a pseudo-random sequence to protect the data to be sent in, e.g., message 203,
PPPP( ) aims at providing a proof for the requesting device about the current received data (e.g., in message 203) and (new) secret internal state.

In an aspect of the invention, a potential choice for above functions is a lightweight hash function, e.g., P( ) in above design may be a one way hash function. The primary station or a requesting entity may compute a hash chain given an initial seed S. The primary station may compute S\hat{ }n=Hash(Hash( . . . n times . . . (Hash(S)) . . . ), i.e., S\hat{ }n is obtained by applying the hash function n times. The initial state of the device is set to S\hat{ }n. The first challenge that the primary station/requesting device sends is S\hat{ }{n−1} so that the device 200 needs to check whether S\hat{ }n equals Hash(S\hat{ }{n−1}). In this case, functions PP( ) just replaces the old internal state by a newly received challenge. PPP( ) and PPPP( ) may also be based on the same hash function. For instance, PPP( ) may be a hash function that takes as input the IS and/or the received challenge or another secret/internal state to derive a pseudo-random bit sequence that is used for encryption of the data by XORing the data with said pseudo-random bit sequence. For instance, PPPP( ) may be the hash function that takes as input the IS and/or the received challenge or another secret/internal state and/or data to compute a sort of MIC.

In an aspect of the invention, the one-way hash function may be based on ASCON.

In a further aspect of the invention, one or multiple PUFs may serve as the one-way functions P( ) PP( ) PPP( ) PPP( ) For instance, a first PUF( ) is used as P( ) and a second PUF( ) is used as PPP( ). In a further aspect of the invention, the one way hash function may be based on ASCON Hash or ASCON XOF.

In a further aspect of the invention, some of above functions may also be based on ASCON Authenticated Encryption, e.g., functions PPP( ) and PPPP( ) may be based on ASCON Authenticated Encryption.

In a further aspect of the invention, ED 200, i.e., the ambient IoT tag, may be configured with one or more identities, e.g., of the primary station, of the requesting entity, of the seek service, of the type of ED addressed by the message, of the IoT group, etc, entitled to retrieve data/send a request 202. This identity/ies may be included in message 202 (e.g., as part of the “system information”). The type of EDs addressed by the message may refer to the capabilities of the addressed EDs, e.g., EDs with more or less resource capabilities. The ED/tag 200 may only process the message further if the identity/ies included in message 202 matches a pre-configured identity or set of identities. This aspect of the invention serves as first filter for the ED 200 to only reply to those messages intended to it. This is beneficial to, e.g., reduce the amount of replies to a broadcast message 202.

In a further aspect of the invention, the initial message 202 including the “protection field” may include a flag indicating the mode of the primary station where the mode may be, e.g., “identifying” or “identified”. In mode “identifying”, the primary station is identifying ED/IoT tag by requesting the ED/IoT just to reply to the input message, e.g., by providing an identifier back, or the response to a challenge, in one or multiple frequencies. The response back may be message 203 that also includes the “security information request”. The primary station may then profile the answers of the ED/IoT device to identify it by sending multiple messages 202 and receiving multiple messages 203. This profiling may be based, e.g., on the radio frequency (RF) properties of the wireless transmitter (Tx) of the ED since the device specific aspects of the Tx make it identifiable. Thus, the RF properties of the Tx act as a PUF. Once the ED has been identified by the primary station (or a requesting entity behind the primary station), the ED is sent a message 202 including a mode “identified”. This message may also be message 204 with the requested security information. The sending of this message may implicitly mean that device ED has been identified. Since it has been identified, the security information may be specific for the device, e.g., may be using a challenge for an ED PUF whose response is known to the primary station, or it may be using a challenge so that the ED can compute a MIC by using a key K known to the primary station. Additionally or alternatively, the primary station may send a MIC itself computed with a key known the ED and using as input a NONCE that was received in a message from the ED during the identification phase. Upon reception of this message that indicates that the primary station has identified the ED, the ED may proceed to provide the primary station with the requested data (e.g., its protected identity, or protected sensed data), etc if, e.g., the primary station has been verified by the ED based on the security information provided by the primary station.

In a further aspect of the invention, since generating random data in a resource constraint device may be difficult, the device may generate random data by passing the currently received wireless signal to a function such as a hash function, HMAC, PUF, . . . and using output as random data. To make sure that an attacker cannot easily manipulate the input, and therefore, the output, the tag may keep a secret raw value R (e.g., in a memory) and XOR/prepend/append/insert it with the received wireless signal before passing it to the function. In general, the input to the function is a second function of a secret value R and the measured wireless signal. Additionally, the secret raw value R may be updated after every iteration. For instance, if the function outputs a value W, then b bits of W may be used as the second NONCE and k different bits of W may be used to update the secret raw value R, e.g., by replacing the old value R or obtaining a new value R as a third function of the old value R and the k selected bits of W, e.g., R_new=R_old XOR W_k where R_new is the new secret raw value R, W_k are the selected k bits of W, and R_old is the old secret raw value R.

In a further aspect of the invention, an ED may receive in message 204, together with the security information, information that it may use in subsequent interactions. For instance, the ED may keep in memory a pseudonym. The ED may use this pseudonym to identify itself, e.g., when sending the “security information request” in message 203. When the ED receives message 204, and the ED verifies said security information, the ED may also update the pseudonym that it currently had in memory with the new pseudonym. This action must only be applied if the ED verifies said security information successfully. The newly received pseudonym may be protected by XORing it with a random bit string that may be the output of a function as the ones described in other aspects of the invention, e.g. a PUF. Message 204 may also include the challenge known by the primary station or the requesting entity that when applied to the function generates the random bit string used for the encryption of the pseudonym.

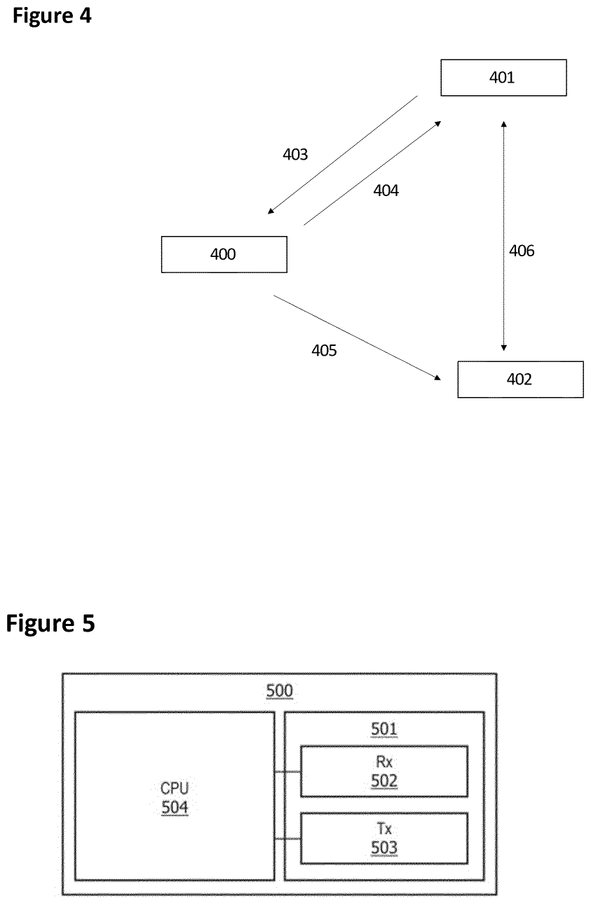

FIG. 4 describes another potential deployment option of the invention wherein entities 401 and 402 refer to primary stations, e.g., both of them may be base stations, or 401 may be a UE and 402 may be a base station, etc, and entity 400 represents an ED or ambient IoT device. Message 403 represents the distribution of a system information message including a protected field. Upon reception of 403, entity 400 may reply with a message 404 towards entity 401, e.g., a secure message or a message with a security information request. This reply resembles many of the variants discussed so far. Additionally or alternatively, entity 400 may send/forward message 405 towards entity 402. This message 405 may be a backscattered message by the ED/ambient IoT device. It is to be noted that since entity 402 is the entity receiving message 405 in this alternative, this may require entity 402 to send an initial message 406 before message 403 is sent with the security configuration. Alternatively, entity 401 may generate some parameters are random, e.g., a NONCE or the RF communication parameters, and send it to entity 402 in message 406 so that entity 402 can take them into account when identifying/authenticating ED 400, i.e., in this alternative message 406 goes from 401 to 402. In general, message 406 represents the exchange of security information between primary station 401 and 402 to enable the identification and/or authentication of ED 400.

FIG. 4 illustrates therefore how the message flow of FIG. 2 may be applied in a distributed environment wherein entity 400 may receive a first message (system information message with a protection field) from a first primary station and entity 400 may send a further message 404 or 405 to the first primary station or a second primary station. FIG. 4 illustrates the need of coordination between the first and second primary stations regarding the exchanged security data.

Different aspects of the invention can be combined with each other as appropriate.

Thus, as seen in the previous description, it is proposed a whole system to reduce the possibility of attacks based on False Base Stations or Man in the Middle and allow the verification of the system information distributed by access devices/primary stations. The components of this system include a secondary station and a primary station implementing one or more of the mentioned embodiments. The apparatus may be implemented by a program code means of a computer program and/or as dedicated hardware of the related devices, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.

1. An apparatus comprising:
a controller circuit;
a receiver circuit; and
a transmitter circuit,
wherein the receiver circuit is arranged to receive a first system information message,
wherein the first system information message is sent from or through a first primary station,
wherein the controller circuit is arranged to decode the first system information message,
wherein the controller circuit is arranged to obtain a protection field,
wherein the controller circuit is arranged to use the protection field to determine a location of a security information,
wherein the controller circuit is arranged to use security information to verify the received message and/or the first primary station and/or to cause the transmitter circuit to send a subsequent secure message to the first primary station or to a third primary station.

2. The apparatus of claim 1,
wherein the controller circuit is arranged to send a security information request to the first primary station or the third primary station,
wherein the controller circuit is arranged to receive security information from the first primary station,
wherein the controller circuit is arranged to use the received security information to verify the previously received first system information message or a second system information message received from a second primary station.

3. The apparatus of claim 2, wherein the controller circuit is arranged to send the security information request based on the location of the security information.

4. The apparatus of claim 2,
wherein the controller circuit is arranged to send a security information request to a first primary station or a third primary station,
wherein the security information request requires the security information for the verification of system information message,
wherein the request is sent if at least one of the following conditions are met:
the apparatus belongs to a type;
the system information message is transmitted by a primary station with an identity;
the system information message is transmitted at a time or a time frame; and
the system information message is transmitted in an area.

5. The apparatus of claim 1, wherein the security information of the first primary station is retrieved from a distributed ledger.

6. The apparatus of claim 2, wherein the security information request is sent in an initial Physical Random Access Channel message.

7. The apparatus of claim 1,
wherein a freshness of the first system information message is verified by comparing the local time of the apparatus with the signing time of the security information after correction with the timing advance,
wherein the timing advance is indicated by the primary station,
wherein the timing advance is securely protected using the security information.

8. The apparatus of claim 1,
wherein the controller circuit is arranged to receive a second system information message,
wherein the controller circuit is arranged to verify the second system information message based on the security information received to verify the first system information message.

9. The apparatus of claim 8, wherein the controller circuit uses a Merkle tree structure to verify the second system information message.

10. The apparatus of claim 1,
wherein the protection field in the first system information message comprises a challenge,
wherein the controller circuit uses the challenge, a first function P( ) and a secret internal state variable to verify the primary station.

11. The apparatus of claim 1,
wherein the protection field comprises at least one identities,
wherein the controller circuit uses the at least on one identities to determine whether the controller circuit needs to further process the received first system information message.

12. The apparatus of claim 10, wherein the secret internal state variable is updated based at least on the received challenge, the previous value of the secret internal state variable and a second function PP( ).

13. The apparatus of claim 1, wherein the subsequent secure message comprises data that is confidentiality protected based on the information in the protection field, the secret internal state information, and a third variable PPP( ).

14. The apparatus of claim 1, wherein the subsequent secure message is integrity protected and/or a proof of the new secret internal state is obtained based on the information in the protection field, the secret internal state information, and a fourth function PPPP( ).

15. The apparatus of claim 10, wherein the first, second, third, and fourth functions are at least one of:
a physical unclonable function;
a list of challenge-response values stored in memory;
a secret permutation;
a hash function such as ASCON-HASH;
an extendable output function such as ASCON-XOF; and
an authenticated encryption algorithm such as ASCON-AE.

16. An apparatus comprising:
a controller circuit;
a receiver circuit; and
a transmitter circuit,
wherein the controller circuit is arranged to cause the transmitter circuit to broadcast a first system information message,
wherein the first system information message comprises a protection field,
wherein the receiver circuit is arranged to receive a security information request and/or a secure message from an end device.

17. The apparatus of claim 16,
wherein the controller circuit is arranged to securely process the secure message by extracting data included in the secure message based on the information in the protection field,
wherein the secret internal state information of the end device, and/or
wherein the controller circuit is arranged to determine security information for the first system information message and transmit the security information.

18. The apparatus of claim 17,
wherein the receiver circuit is arranged to receive a second secure message,
wherein the controller circuit is arranged to securely process the second secure message.

19. The apparatus of claim 17, wherein the a random-access response message comprises the security information.

20. The apparatus of claim 17,
wherein the security information integrity is arranged to protect fields in the random-access response message such as the timing advance and/or
wherein the security information integrity is arranged to protect properties of the security information request message.

21. A method comprising:
receiving a first system information message from or through a first primary station;
decoding the first system information message;
obtaining a protection field;
using the protection field to determine a location of security information;
using the security information to verify the received message and/or first primary station and/or send a subsequent secure message to the first primary station.

22. A method comprising:
broadcasting a first system information message, wherein the first system information message comprises a protection field; and
receiving a security information request and/or a secure message from an end device.

23. (canceled)

24. A computer program stored on a non-transitory medium, wherein the computer program when executed on a processor performs the method as claimed in claim 21.

25. A computer program stored on a non-transitory medium, wherein the computer program when executed on a processor performs the method as claimed in claim 22.

26. The method of claim 21, further comprising:
sending a security information request to the first primary station or the third primary station;
receiving security information from the first primary station; and
using the received security information to verify the previously received first system information message or a second system information message received from a second primary station.

27. The method of claim 21, further comprising sending the security information request based on the location of the security information.

28. The method of claim 26, further comprising sending a security information request to a first primary station or a third primary station,
wherein the security information request requires the security information for the verification of system information message,
wherein the request is sent if at least one of the following conditions are met:
the apparatus belongs to a type;
the system information message is transmitted by a primary station with an identity;
the system information message is transmitted at a time or a time frame; and
the system information message is transmitted in an area.

29. The method of claim 21, wherein the security information of the first primary station is retrieved from a distributed ledger.

30. The method of claim 26, wherein the security information request is sent in an initial Physical Random Access Channel message.

31. The method of claim 21,
wherein a freshness of the first system information message is verified by comparing the local time of the apparatus with the signing time of the security information after correction with the timing advance,
wherein the timing advance is indicated by the primary station,
wherein the timing advance is securely protected using the security information.

32. The method of claim 21, further comprising:
receiving a second system information message,
verifying the second system information message based on the security information received to verify the first system information message.

33. The method of claim 32, further comprising using a Merkle tree structure to verify the second system information message.

34. The method of claim 21, further comprising using a challenge, a first function P( ) and a secret internal state variable to verify the primary station, wherein the protection field in the first system information message comprises the challenge.

35. The method of claim 21, further comprising using the at least on one identities to determine whether the controller circuit needs to further process the received first system information message, wherein the protection field comprises the at least one identities.

36. The method of claim 34, wherein the secret internal state variable is updated based at least on the received challenge, the previous value of the secret internal state variable and a second function PP( ).

37. The method of claim 21, wherein the subsequent secure message comprises data that is confidentiality protected based on the information in the protection field, the secret internal state information, and a third variable PPP( ).

38. The method of claim 21, wherein the subsequent secure message is integrity protected and/or a proof of the new secret internal state is obtained based on the information in the protection field, the secret internal state information, and a fourth function PPPP( ).

39. The method of claim 22,
wherein the controller circuit is arranged to securely process the secure message by extracting data included in the secure message based on the information in the protection field,
wherein the secret internal state information of the end device, and/or
wherein the controller circuit is arranged to determine security information for the first system information message and transmit the security information.

40. The method of of claim 22,
wherein the receiver circuit is arranged to receive a second secure message,
wherein the controller circuit is arranged to securely process the second secure message.

41. The method of claim 22, wherein the a random-access response message comprises the security information.

42. The method of claim 22,
wherein the security information integrity is arranged to protect fields in the random-access response message such as the timing advance and/or
wherein the security information integrity is arranged to protect properties of the security information request message.
